(19) United States
(12) Patent Application Publication
(10) Pub. No.: US 2006/0176496 A1
(43) Pub. Date: Aug. 10, 2006

(54) Extensible transformation framework

(76) Inventors: Leshek Fiedorowicz, Morgan Hill, CA (US); Michael Yiupun Kwong, Stanford, CA (US); Rebecca Lau Poole, San Jose, CA (US)

Correspondence Address: SAWYER LAW GROUP LLP, P.O. Box 51418, Palo Alto, CA, 94303, US

(21) Appl. No.: 11/051,234

(22) Filed: Feb. 4, 2005

(51) Int. Cl. G06F 3/12

(52) U.S. Cl. 358/1.13

(57) ABSTRACT

A method and system providing an extensible transformation framework have been disclosed. The framework in accordance with the method and system receives a plurality of artifacts as input. The framework calls classifiers to determine a type for each of the plurality of artifacts. The classifier may not group together a set of artifacts related to each of the plurality of artifacts. The classifiers create work units for each artifact containing information appropriate for the artifact's type. The framework then calls the transformation algorithm corresponding to each artifact's type to transform the artifacts. In this manner, the framework automatically classifies and groups different types of artifacts and performs the appropriate transformation of each artifact. The framework is also extensible, such that more artifact types and corresponding transformation algorithms can be added.

### FIELD OF THE INVENTION

The present invention relates to artifact transformation, and more particularly to an extensible framework for automated artifact transformation.

### BACKGROUND OF THE INVENTION

As technology changes and advances, legacy applications, code, documents, or data need to be migrated or transformed. Conventional transformation processes are either manually performed or limited to particular artifact types. However, this is cumbersome when a large number of artifacts need to be transformed. This process is further complicated by the fact that different types of artifacts may be mixed together.

Accordingly, there exists a need for a method and system for providing an extensible transformation framework. The framework should be able to automatically classify different types of artifacts and perform the appropriate transformation of each artifact. The framework should also be extensible such that more artifact types and corresponding transformation algorithms can be added. This is useful when additional artifact types may need to be handled in the future, or when a third party vendor has the expertise to handle particular artifact types. The present invention addresses such a need.

### SUMMARY OF THE INVENTION

A method and system providing an extensible transformation framework have been disclosed. The framework in accordance with the method and system receives a plurality of artifacts as input. The framework calls classifiers to determine a type for each of the plurality of artifacts. The classifiers create work units for each artifact or group of related artifacts (as grouped and determined by the classifier) containing information appropriate for the artifact's type. The framework then calls the transformation algorithm corresponding to each artifact's type to transform the artifacts. In this manner, the framework automatically classifies different types of artifacts, optionally grouping related artifacts in a way that is consistent to the artifact type, and performs the appropriate transformation of each artifact or group of artifacts. The framework is also extensible, such that more artifact types and corresponding transformation algorithms can be added.

### BRIEF DESCRIPTION OF THE FIGURES

FIGS. 1 and 2 illustrate an embodiment of a system and method, respectively, for providing an extensible transformation framework in accordance with a preferred embodiment of the present invention.

FIG. 3 is a flowchart illustrates in more detail the classification (and optionally grouping) of artifacts in accordance with a preferred embodiment of the present invention.

FIG. 4 is a flowchart illustrating in more detail the transformation of artifacts in accordance with a preferred embodiment of the present invention.

FIG. 5 illustrates an example of the classification and transformation processes in accordance with a preferred embodiment of the present invention.

FIG. 6 illustrates a software implementation of the method in accordance with a preferred embodiment of the present invention.

### DETAILED DESCRIPTION

The present invention provides a method and system for providing an extensible transformation framework. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

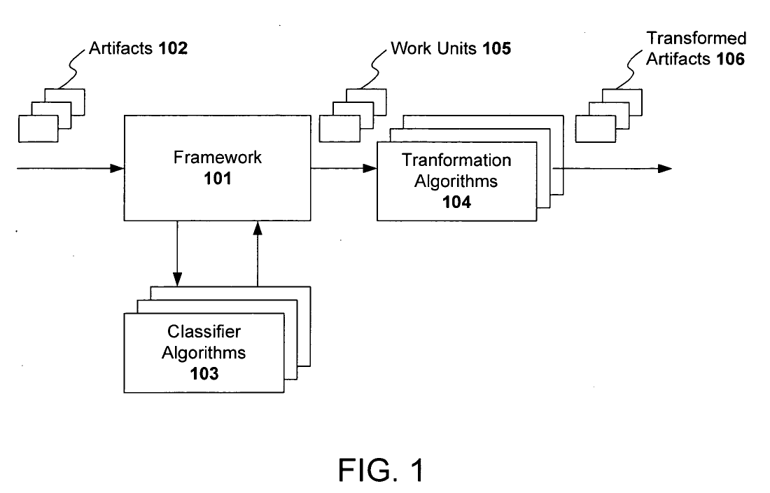

To more particularly describe the features of the present invention, please refer to FIGS. 1 through 6 in conjunction with the discussion below.

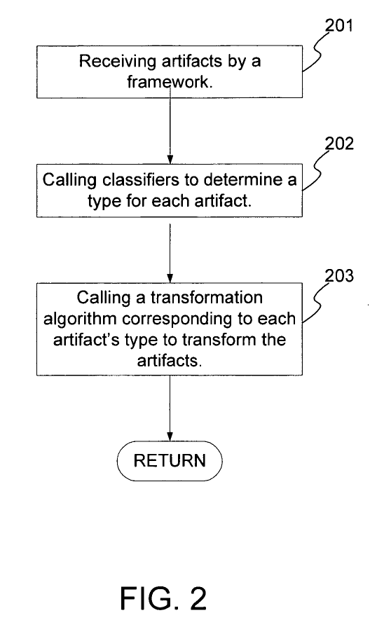

FIGS. 1 and 2 illustrate an embodiment of a system and method, respectively, for providing an extensible transformation framework in accordance with a preferred embodiment of the present invention. The system includes a framework 101 that receives artifacts 102, via step 201. The artifacts 102 can be software code, documents, data, etc., from any type of source. The source can be a legacy application, file system, database, repository, etc. For a classification process, the framework 101 calls classifiers 103 registered with the framework 101, via step 202, to determine a type for each artifact. The classifiers may also group and collect the set of related artifacts using an algorithm that is appropriate for the artifact type. For instance, an XML document and other XML documents that it refers to may be grouped together for transformation purposes. Then for a transformation process, a transformation algorithm 104 corresponding to each artifact's type is called, via step 203, to transform the artifacts. In this embodiment, as the artifacts 102 are classified and grouped, work units 105 are created. The work units 105 are objects used to pass information discovered during the classification to the transformation algorithms 104. There may be one artifact per work unit, or a group of related artifacts per work unit, depending on the classifier and type of artifacts. In the case of a group of artifacts, the entire group will be transformed together. The transformation algorithm 104 to be called for an artifact is determined based on this information. The transformation algorithm 104 called then performs the transformation and outputs the transformed artifact 106.

In this manner, the artifacts 102 can be of mixed types and can be treated in a uniform way by the framework 101. The different types of artifacts need not be separated manually before transformation. Futhermore, a new artifact type can be added by registering a classifier algorithm for the new type and by providing its corresponding transformation algorithm.

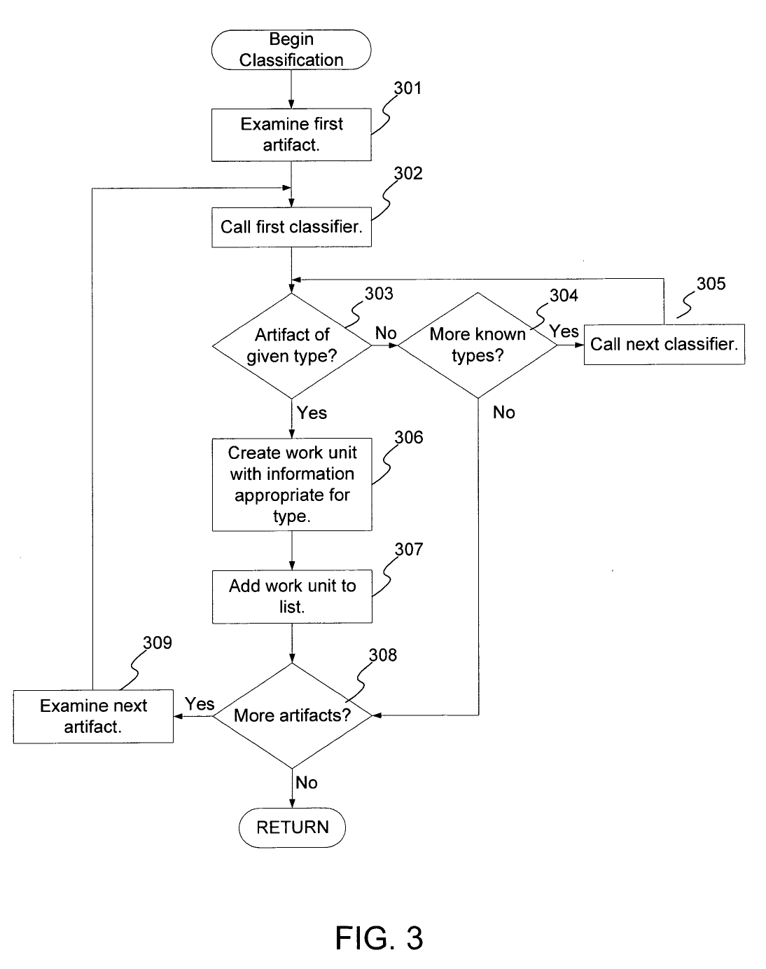

FIG. 3 is a flowchart illustrates in more detail the classification of artifacts in accordance with a preferred embodiment of the present invention. The process begins with the examination of the first artifact, via step 301. The framework 101 calls the first classifier 103, via step 302. If the first classifier algorithm does not recognize the type, via step 303, and if there are more known types, via step 304, then the next classifier 103 is called by the framework 101, via step 305. Steps 303 through 305 are repeated until one of the classifier 103 recognize the artifact's type. When a classifier 103 recognizes the type of the artifact, via step 303, it creates a work unit 105 with the information appropriate for the type, via step 306. The classifier may also look for related artifacts in the input set and include them in the work unit 105, if appropriate. The work unit 105 is then added to a list of work units, via step 307. If none of the classifiers 103 recognize the type of a particular artifact, then no work unit is created for it. Some other action can be performed in this case, such as an entry in a log. If there are more artifacts, via step 308, then the next artifact is examined, via step 309. Steps 302 through 308 are then repeated until each artifact has been examined.

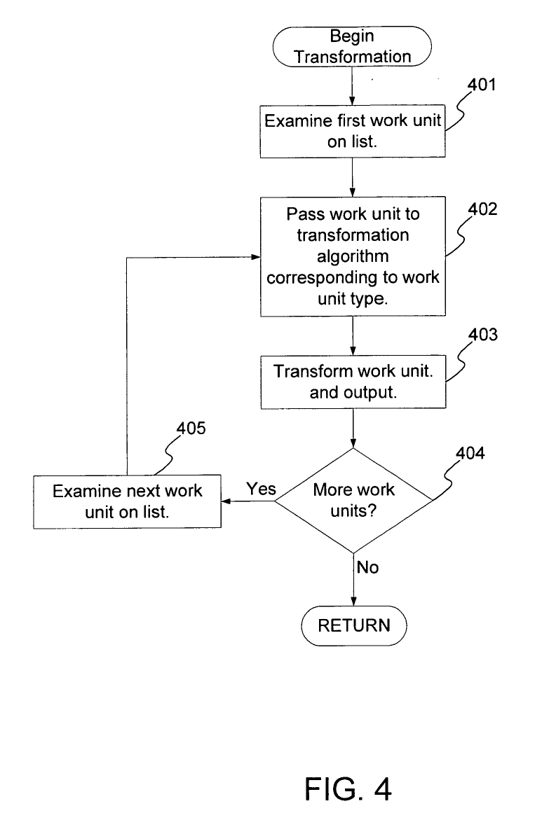

FIG. 4 is a flowchart illustrating in more detail the transformation of artifacts in accordance with a preferred embodiment of the present invention. The framework 101 examines the first work unit, via step 401, on the list of work unit generated during the classification process (FIG. 3). The framework 101 passes this work unit 105 to the transformation algorithm 104 corresponding to the work unit type, via step 402. The work unit 105 is then transformed, and the transformed artifact 106 is outputted, via step 403. If there are more work units on the list, via step 405, then the next work unit on the list is examined, via step 405. Steps 402 through 404 are then repeated until each work unit on the list has been transformed.

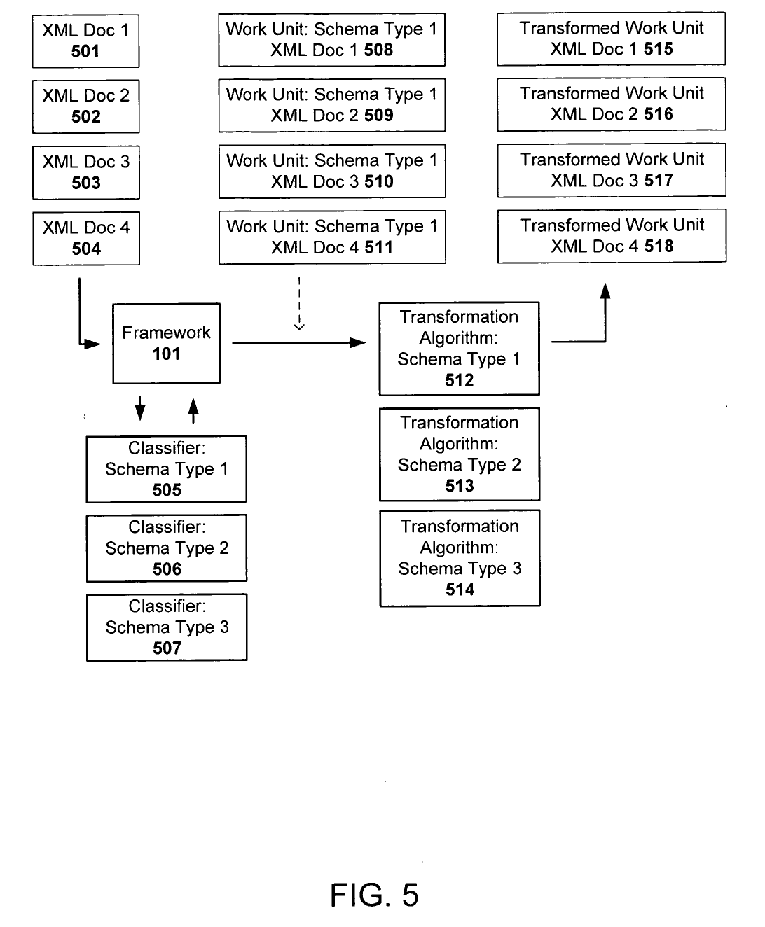

For example, assume that the artifacts 102 are extensible markup language (XML) documents that conform to three different schemas, each schema defining a document type. The XML documents are to be transformed to new schema types. As illustrated in FIG. 5, assume that there is a classifier 505-507 for each schema with a corresponding transformation algorithm 512-514. The framework 101 examines the first XML document 501, via step 301, and calls the first classifier 505, via step 302, which handles schema type 1. The first classifier 505 determines that the first XML document 501 is of schema type 1, via step 303, and creates a work unit 508 for the XML document 501 with the information appropriate for schema type 1, via step 306. This work unit 508 is then added to the list of work units, via step 307.

Since there are more XML documents, via step 308, the framework 101 examines the second XML document 502, via step 309. The framework 101 calls the first classifier 505, via step 302. The first classifier 505 determines that the second XML document 502 is of schema type 1, via step 303, and creates a work unit 509 for the XML document 502 with the information appropriate for schema type 1, via step 306. This work unit 509 is added to the list of work units, via step 307.

The framework 101 then examines the third XML document 503, via step 309. The framework 101 calls the first classifier 505, via step 302. The first classifier 505 does not recognize the third XML document's schema, via step 303. Since there are more known schemas, via step 304, the framework 101 calls the next classifier 506, via step 305, which handles schema type 2. The classifier algorithm 506 determines that the third XML document 503 is of schema type 2, via step 303, and creates a work unit 510 with information appropriate for schema type 2, via step 306. The work unit 510 is added to the list of work units, via step 307.

The framework 101 then examines the fourth XML document 504, via step 309. The framework 101 calls the first classifier 505, via step 302. The first classifier 505 does not recognize the fourth XML document's schema, via step 303. The framework 101 then calls the second classifier 506, via step 305. The second classifier 506 also does not recognize the fourth XML document's schema, via step 303. The framework 101 then calls the third classifier 507, via step 305. The third classifier 507 determines that the fourth XML document 504 is of schema type 3, via step 303, and creates a work unit 511 with information appropriate for schema type 3, via step 306. The work unit 511 is added to the list of work units, via step 307.

Once each of the XML documents 501-504 has been classified, the framework 101 performs the transformation process. This process begins with the framework 101 examining the first work unit 508 on the list, via step 401. The work unit 508 is then passed to the transformation algorithm 512 corresponding to schema type 1, via step 402. The transformation algorithm 512 transforms the work unit 508 into the transformed XML document 515 and outputs it, via step 403.

Since there are more work units on the list, via step 404, the framework 101 examines the next work unit 509 on the list, via step 405. The framework 101 passes the work unit 509 to the transformation algorithm 512 corresponding to schema type 1, via step 402. The transformation algorithm 512 transforms the work unit 509 into the transformed XML document 516 and output its, via step 403.

The framework 101 then examines the next work unit 510 on the list, via step 405. The framework 101 passes the work unit 510 to the transformation algorithm 513 corresponding to schema type 2, via step 402. The transformation algorithm 513 transforms the work unit 510 into the transformed XML document 517 and output its, via step 403.

The framework 101 then examines the next work unit 511 on the list, via step 405. The framework 101 passes the work unit 511 to the transformation algorithm 514 corresponding to schema type 3, via step 402. The transformation algorithm 514 transforms the work unit 511 into the transformed XML document 518 and output its, via step 403.

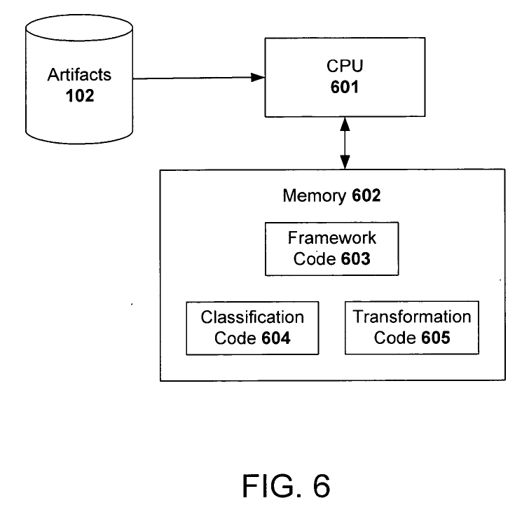

In this embodiment, the method in accordance with a preferred embodiment of the present invention is implemented in software. As illustrated in FIG. 6, a central processing unit (CPU) 601 executes the framework code 603, classification code 604, and/or the transformation code 605 on a set of artifacts 102, as set forth above. The code can be stored in a memory 502 or some other computer readable medium. The CPU 601 can reside on a client device, remote server, or in any other part of the system.

A method and system providing an extensible transformation framework have been disclosed. The framework in accordance with the method and system receives a plurality of artifacts as input. The framework calls classifiers to determine a type for each of the plurality of artifacts. The classifiers create work units for each artifact containing information appropriate for the artifact's type. The framework then calls the transformation algorithm corresponding to each artifact's type to transform the artifacts. In this manner, the framework automatically classifies different types of artifacts and performs the appropriate transformation of each artifact. The framework is also extensible, such that more artifact types and corresponding transformation algorithms can be added.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for providing an extensible transformation framework, comprising:
(a) receiving a plurality of artifacts by the framework;
(b) calling at least one classifier to determine a type for each of the plurality of artifacts; and
(c) calling at least one transformation algorithm corresponding to each artifact's type to transform the plurality of artifacts.

2. The method of claim 1, wherein the at least one classifier groups the plurality of artifacts as appropriate for the type.

3. The method of claim 1, wherein for each of the plurality of artifacts, the calling (b) comprises:
(b1) calling a first of a plurality of classifiers, wherein if the first classifier recognizes the type of the artifact, the first classifier creates a work unit corresponding to the artifact, wherein the work unit comprises information appropriate for the type for the artifact; and
(b2) calling another of the plurality of classifiers if the first classifier does not recognize the type of the artifact.

4. The method of claim 3, wherein the calling (b2) is repeated until one of the plurality of classifiers recognizes the type of the artifact or until each of the plurality of classifiers has been called.

5. The method of claim 1, wherein the calling (b) further comprises:
(b1) receiving a plurality of work units corresponding to the plurality of artifacts, wherein each of the plurality of work units comprises information appropriate for the type of the corresponding artifact.

6. The method of claim 5, wherein for each of the plurality of work units, the calling (c) comprises:
(c1) calling one of a plurality of transformation algorithms according to the information in the work unit, wherein the called transformation algorithm transforms the corresponding artifact.

7. The method of claim 1, further comprising:
(d) adding to the framework a classifier and a corresponding transformation algorithm for a new artifact type.

8. A system, comprising:
a framework, wherein the framework receives a plurality of artifacts;
at least one classifier, wherein the framework calls the at least one classifier to determine a type of each of the plurality of artifacts; and
at least one transformation algorithm, wherein the framework calls the at least one transformation algorithm corresponding to each artifact's type to transform the plurality of artifacts.

9. The system of claim 8, wherein the at least one classifier groups the plurality of artifacts as appropriate for the type.

10. The system of claim 8, wherein for each of the plurality of artifacts, the framework calls a plurality of classifiers until one of the plurality of classifiers recognizes the type of the artifact or until each of the plurality of classifiers has been called, wherein if one of the plurality of classifiers recognizes the type of the artifact, then the classifier creates a work unit corresponding to the artifact , wherein the work unit comprises information appropriate for the type of the artifact.

11. The system of claim 8, wherein the framework receives a plurality of work units corresponding to the plurality of artifacts, wherein each of the plurality of work units comprises information appropriate for the type of the corresponding artifact.

12. The system of claim 11, wherein for each of the plurality of work units, the framework calls one of a plurality of transformation algorithms according to the information in the work unit, wherein the called transformation algorithm transforms the corresponding artifact.

13. The system of claim 8, wherein the framework is extensible, wherein a classifier and a corresponding transformation algorithm for a new artifact type can be added to the framework.

14. A computer readable medium with program instructions for providing an extensible transformation framework, comprising:
(a) receiving a plurality of artifacts by the framework;
(b) calling at least one classifier to determine a type for each of the plurality of artifacts; and
(c) calling at least one transformation algorithm corresponding to each artifact's type to transform the plurality of artifacts.

15. The medium of claim 14, wherein the at least one classifier groups the plurality of artifacts as appropriate for the type.

16. The medium of claim 14, wherein for each of the plurality of artifacts, the calling (b) comprises:
(b1) calling a first of a plurality of classifiers, wherein if the first classifier recognizes the type of the artifact, the first classifier creates a work unit corresponding to the artifact, wherein the work unit comprises information appropriate for the type of the artifact; and
(b2) calling another of the plurality of classifiers if the first classifier does not recognize the type of the artifact.

17. The medium of claim 16, wherein the calling (b2) is repeated until one of the plurality of classifiers recognized the type of the artifact or until each of the plurality of classifiers has been called.

18. The medium of claim 14, wherein the calling (b) further comprises:
(b1) receiving a plurality of work units corresponding to the plurality of artifacts, wherein each of the plurality of work units comprises information appropriate for the type of the corresponding artifact.

19. The medium of claim 18, wherein for each of the plurality of work units, the calling (c) comprises:
(c1) calling one of a plurality of transformation algorithms according to the information in the work unit, wherein the called transformation algorithm transforms the corresponding artifact.

20. The medium of claim 14, further comprising:
(d) adding to the framework a classifier and a corresponding transformation algorithm for a new artifact type.
